(19) United States
(12) Patent Application Publication
(10) Pub. No.: US 2014/0176871 A1
(43) Pub. Date: Jun. 26, 2014

(54) DISPLAY APPARATUS

(71) Applicants: HEFEI BOE DISPLAY LIGHT CO., LTD., Hefei (CN); BOE TECHNOLOGY GROUP CO., LTD., Beijing (CN)

(72) Inventors: Zuchuan Shi, Beijing (CN); Qinggang Feng, Beijing (CN)

(73) Assignees: HEFEI BOE DISPLAY LIGHT CO., LTD., Hefei (CN); BOE TECHNOLOGY GROUP CO., LTD., Beijing (CN)

(21) Appl. No.: 14/099,366

(22) Filed: Dec. 6, 2013

(30) Foreign Application Priority Data
Dec. 10, 2012 (CN) 201210530756.8

(51) Int. Cl. F21V 8/00

(52) U.S. Cl. CPC G02B 6/0063; G02B 6/0053
USPC 349/65

(57) ABSTRACT

The present application discloses a A display apparatus is disclosed comprising a LCD panel, a brightness enhancement film, a light guidance plate, and a light emitting unit. The light guidance plate is made of thermoplastic material doping with nanometer light dissipation particulates. The LCD panel is disposed on at least one light emitting surface side of the light guidance plate. The brightness enhancement film is disposed between the LCD panel and the light guidance plate. The light emitting unit is disposed on at least one light incident end surface side of the light guidance plate and provided as a light source. The display apparatus of the present disclosure can reduce the cost, the thickness and the weight.

### CROSS-REFERENCE TO RELATED APPLICATION

This application claims the benefit of Chinese Patent Application No. 201210530756.8 filed on Dec. 10, 2012 in the State Intellectual Property Office of China, the whole disclosure of which is incorporated herein by reference.

### BACKGROUND OF THE INVENTION

1. Field of the Invention

The present invention relates to a display apparatus.

2. Description of the Related Art

Conventionally, a display apparatus generally comprises a LCD panel, a brightness enhancement film, a light guidance plate, a light emitting unit and the like. For a conventional light guidance plate, during operation, a number of mesh points on a surface of an acrylics sheet material destroy total reflection, in combination with the reflecting effect of the bottom reflection sheet, the light is emitted from a surface opposite to the surface having the mesh points; the emitted light passes through a lower dissipation sheet and obtains a fogging effect, such that the display apparatus can perform normal display. The manufacture cost for the above conventional light guidance plate is high, and the light guidance plate has a large thickness and thus the whole display apparatus has a large thickness.

In particular, for a double-side display apparatus, the above problems are much worse. The double-side display apparatus is a new display apparatus having two display screens and is more and more widely used in various service counters and windows due to its good appearance and performance. The light guidance plate used in conventional double-side display apparatus is of a type by which light is emitted from one side. Therefore, it needs to combine two light guidance plates together to form an integral structure. Thus, the conventional light guidance plate is thick and has a high manufacture cost; further, since the conventional display apparatus needs two dissipation sheets, its thickness is much large. The above problems lead to limited use of the double-side display apparatus.

### SUMMARY OF THE INVENTION

The present invention has been made to overcome or alleviate at least one aspect of the above mentioned disadvantages.

Accordingly, it is an object of the present invention to provide a display apparatus with low cost, thin thickness and light weight.

An aspect of the present invention provides a display apparatus comprising a LCD panel, a brightness enhancement film, a light guidance plate and a light emitting unit, wherein the light guidance plate is made of thermoplastic material doping with nanometer light dissipation particulates; the LCD panel is disposed on at least one light emitting surface side of the light guidance plate; the brightness enhancement film is disposed between the LCD panel and the light guidance plate; the light emitting unit is disposed on at least one light incident end surface side of the light guidance plate and provided as a light source.

### BRIEF DESCRIPTION OF THE DRAWINGS

The above and other features of the present invention will become more apparent by describing in detail exemplary embodiments thereof with reference to the accompanying drawings, in which:

FIG. 1 is a schematic structural view of the display apparatus according to an exemplary embodiment of the present invention.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

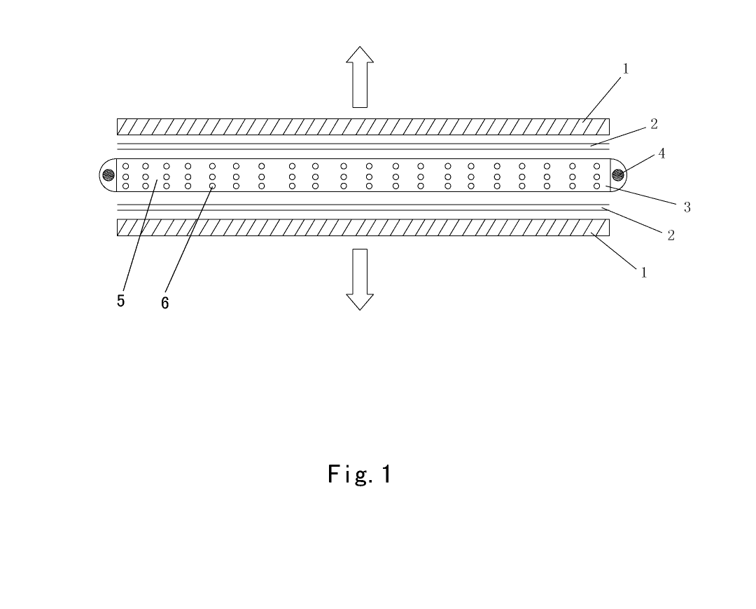

As shown in FIG. 1, a display apparatus according to an exemplary embodiment of the present invention comprises a LCD panel 1, a brightness enhancement film 2, a light guidance plate 3 and a light emitting unit 4. The light guidance plate 4 is made of thermoplastic material 5 doped with nanometer light dissipation particulates 6. According to this embodiment, there are two LCD panels 1, which are respectively disposed on two opposite sides of the light guidance plate 3, i.e., an upper light emitting surface side and a lower light emitting surface side of the light guidance plate 3. Accordingly, there are two brightness enhancement films 2, which are respectively disposed between two LCD panels 1 and the upper light emitting surface and the lower light emitting surface of the light guidance plate 3. In addition, the two light emitting units 4 are respectively disposed on the left and right light incident end surface sides of the light guidance plate 3 and provided as light sources, such as a LED light source or a CCFL (cold cathode fluorescent lamp) light source or an OLED (organic light-emitting diode) light source.

The above thermoplastic material 5 is acrylic material. According to other embodiments, the thermoplastic material may be PMMA (Polymethylmethacrylate) , PC (Polycarbonate), PS (Polystyrene)or other transparent organic macromolecule polymeric material.

According to an embodiment, the light dissipation particulates 6 for example may be SiO₂ particulates, TiO₂ particulates or other transparent or translucent particulates. Preferably, the refractive index of the light dissipation particulates is substantially different from that of the thermoplastic material.

According to an exemplary embodiment, the light guidance plate is manufactured according to the following process: mixing particulates such as PMMA particulates with light dissipation particulates; passing the mixed particulates into a heating device; heating the PMMA particulates and fusing them, while making the PMMA material and the light dissipation particulates mixed evenly by stirring or shearing; and then, forming the light guidance plate by extrusion or injection molding.

According to another embodiment, the light emitting unit may be disposed on only one of the left and right light incident end surface sides of the light guidance plate 3.

According to another embodiment, the brightness enhancement film and the LCD panel may be provided on only one of the light emitting surface sides of the light guidance plate 3.

### Advantages

According to the light guidance plate and the display apparatus of embodiments of the present invention, because nanometer light dissipation particulates are used, the outputting light has a good fogging effect. In comparison with the conventional double-side display apparatus, the display apparatus of the present invention dispenses with a light guidance plate, two bottom reflection sheets and two lower dissipation sheets, and therefore the manufacture cost is saved and the thickness of the display apparatus is reduced. Further, if the display apparatus of the present invention is used as a single side display apparatus, the same effect can be obtained.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A display apparatus comprising:
a LCD panel;
a brightness enhancement film;
a light guidance plate; and
a light emitting unit,
wherein the light guidance plate is made of thermoplastic material doped with nanometer light dissipation particulates;
the LCD panel is disposed on at least one light emitting surface side of the light guidance plate;
the brightness enhancement film is disposed between the LCD panel and the light guidance plate; and
the light emitting unit is disposed on at least one light incident end surface side of the light guidance plate and provided as a light source.

2. The display apparatus according to claim 1,
wherein the light emitting unit is a LED light source, a CCFL light source or an OLED light source.

3. The display apparatus according to claim 1,
wherein the thermoplastic material is acrylic material or transparent organic macromolecule polymeric material.

4. The display apparatus according to claim 1,
wherein there are two LCD panels, respectively disposed on an upper light emitting surface side and a lower light emitting surface side of the light guidance plate.

5. The display apparatus according to claim 4,
wherein there are two brightness enhancement films, respectively disposed between the light guidance plate and the two LCD panels.
